(19) United States
(12) Patent Application Publication
(10) Pub. No.: US 2014/0076879 A1
(43) Pub. Date: Mar. 20, 2014

(54) LIGHTER

(71) Applicants: Yin YE, Shenzhen (CN); Xiaonan WANG, Guangzhou (CN)

(72) Inventors: Yin YE, Shenzhen (CN); Xiaonan WANG, Guangzhou (CN)

(21) Appl. No.: 14/088,430

(22) Filed: Nov. 24, 2013

Related U.S. Application Data
(63) Continuation-in-part of application No. PCT/CN2012/076021, filed on May 24, 2012.

(30) Foreign Application Priority Data
Jun. 1, 2011 (CN) 201120185957.X

(51) Int. Cl. F23Q 7/14; G07D 7/12

(52) U.S. Cl. CPC F23Q 7/14; G07D 7/121
USPC 219/262

(57) ABSTRACT

A lighter, including: a casing, a turnable cap, a circuit board, a transformer, a power supply, switches, circuits, a power socket, an ignition chamber, and a pair of discharging needles. The circuit board is arranged inside the casing, and the discharging needles are disposed on the top of the ignition chamber. The circuits are disposed on the circuit board and include an oscillating circuit, a DC boost converter circuit, a lighting circuit, and a counterfeit money detector circuit. An ignition switch and a toggle switch are disposed on one side of the casing. The bottom of the casing is provided with a lighting lamp and a counterfeit money detector lamp.

### CROSS-REFERENCE TO RELATED APPLICATIONS

This application is a continuation-in-part of International Patent Application No. PCT/CN2012/076021 with an international filing date of May 24, 2012, designating the United States, now pending, and further claims priority benefits to Chinese Patent Application No. 201120185957.X filed Jun. 1, 2011. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a lighter.

2. Description of the Related Art

Typical lighters employ fuel oil or fuel gas as the energy. Potential hazards exist in the process of production, transportation, storage, sale, and use of the lighters. Disadvantages of the lighters are as follows: first, it damages the atmospheric environment; second, harmful gas produced from the ignition enters the respiratory passage of the user, thereby causing damage to the health of the user; third, the fuel oil and the fuel gas are non-renewable energy, resulting in waste. Furthermore, in severe weather, it is inconvenient to use the lighter because the conventional fuel oil and the fuel gas are unable to ignite.

### SUMMARY OF THE INVENTION

To overcome the safety hazard existing in traditional lighters using fuel oil and fuel gas, prevent the explosion happening in the transportation, improve the atmospheric environment of the ozone layer, lower the consumption of the nonrenewable source, it is one objective of the invention to provide a lighter that has functions of electronic ignition, money detection, and charging, and is safe, environmentally friendly, energy saving, and convenient for use.

To achieve the above objective, in accordance with one embodiment of the invention, there is provided a lighter, comprising: a casing, a turnable cap, a circuit board, a transformer, a power supply, diodes, switches, circuits, a power socket, an ignition chamber, and a pair of high voltage discharging needles. The circuit board is arranged inside the casing, and the discharging needles are disposed on a top of the ignition chamber. The circuits are disposed on the circuit board and comprise an oscillating circuit, a DC boost converter circuit, a lighting circuit, and a counterfeit money detector circuit. An ignition switch and a toggle switch are disposed on one side of the casing; a bottom of the casing is provided with a lighting lamp and a counterfeit money detector lamp.

The oscillating circuit comprises a crystal triode, a first crystal diode, a first resistor, a third capacitor, a primary coil and a secondary coil of the transformer; a series connection of the first resistor and the first crystal diode is connected to the power supply in parallel to the third capacitor; a base electrode of the crystal triode is connected to a series connection point between the first resistor and the first crystal diode via the secondary coil and a switch; a collector of the crystal triode is connected to an positive electrode of the power supply, and an emitter of the crystal triode is connected to a negative electrode of the power supply.

The DC boost converter circuit comprises an integrated circuit, a switching tube, a second diode, a fourth resistor, a fifth resistor, a first capacitor, a second capacitor, and an inductor. A first pin of the integrated circuits connected to a series connection point between the fourth resistor and the fifth resistor; and the other end of the fourth resistor is connected to the negative electrode of the power supply; the second capacitor is in parallel connection with the fifth resistor; the other end of the fifth resistor is connected to the second diode, the first capacitor, a second contact point of a fourth switch; the other end of the second diode is connected to a third pin of a switching tube, and one end of the inductor; the other end of the inductor is connected to a positive electrode of the power supply; the other end of the first capacitor is connected to the negative electrode of the power supply; a second pin of the switching tube is connected to a fourth pin of the integrated circuit; and a first pin of the switching tube is connected to a fifth pin of the negative electrode of the power supply.

The lighting circuit comprises a third diode, a second resistor, a second switch, and a normally closed contact of a negative terminal of the power socket; a series connection of the third diode and the second resistor is connected to the power supply via the second switch and the normally closed contact of a negative terminal of the power socket.

The counterfeit money detector circuit comprises a fourth diode, a third resistor, and a third switch; the fourth diode, the third resistor, and the third switch are in series connection to the power supply.

The transformer comprises the primary coil, the secondary coil, and a tertiary coil, a ratio of coil turn thereof is N₁:N₂:N₃=1:0.5-0.9:50-70. Two ends of the tertiary coil are connected to the pair of high voltage discharging needles in the ignition chamber, respectively. When the coil turn is changed, the output power of the transformer is improved, and the arc ignition temperature is increased, the combustible material is much easier to be combusted, and the volume of the lighter can be much smaller.

In a class of this embodiment, the power supply is a rechargeable battery.

In a class of this embodiment, the toggle switch is a two-pole three-throw switch. The second switch and a first contact point of the fourth switch are connected if the toggle switch is turned upward, that is, the lighting circuit and circuit of power charger charging for the power supply are connected. The third switch K₃ is connected if the toggle switch is turned downward, that is, the counterfeit money detector circuit is connected. The second contact point of the fourth switch is connected if the toggle switch is turned at a middle position, that is, the DC/DC boost converter circuit is connected.

In a class of this embodiment, the ignition switch is a toggle switch or a touching switch.

The power socket cooperates with a conversion plug or a digital line for charging a cell phone or other digital products that is applicable to the battery of a cell phone. The power socket cooperates with a power charger or a solar energy charger for charging the power supply, and the power supply can also be charged by the computer by connecting the two via a USB conversion line. When the first switch is connected, the oscillator works, coupled by the transformer, two ends of the tertiary coil of the transformer produce a high frequent high voltage which is then arc discharged by the pair of high voltage discharging needles inside the ignition chamber. Flame produced from the discharge is used to ignite combustible materials. When the toggle switch is turned upward, the second switch and the first contact point of the fourth switch are connected, thus, the lighting circuit is connected; and the LED white light is lightened and functions as a lighting source.

When the power supply of the invention is required to be charged, a plug of a external power charger or a computer USB interface is inserted into the power socket of the invention through the conversion line, thus, the negative electrode of the power supply of the invention inside the power socket is connected to the negative electrode of the external power supply, the normally closed contact of the negative terminal of the power socket is connected to the second switch of the lighting circuit; whereas the normally closed contact of the negative terminal of the power socket is bounced open by the insertion of the plug of the charger, thus, when the power supply of the invention is charged, the lighting circuit is disconnected.

When the toggle switch is turned downward, the third switch is closed, the counterfeit money detector circuit is connected, and the LED purple light for money detection is lightened, the LED purple light is used as the light source for money detection. When the toggle switch is turned at the middle position, the second contact point of the fourth switch is connected, the DC/DC boost converter circuit works, the DC voltage after voltage boosting is used to charge the cell phone or other digital products that is applicable to battery of a cell phone by the second contact point of the fourth switch. In the open air, the DC power supply of the lighter of the invention can be charged by using the power socket and the solar energy power charger.

In a class of this embodiment, the third diode is an LED white tube, and the fourth diode is an LED purple tube.

Advantages of the invention are as follows:
1. Multifunctional. The lighter of the invention can be used as a fire source, a portable torch, counterfeit money detector, and spare battery for cell phones or other digital products suitable for cell phone battery.
2. Convenient and practical. In the open air, the solar energy charger can be used to charge the DC power supply of the lighter of the invention, so that the lighter obtains recharged power continuously; the invention can used to charge the cell phone or other digital products; the invention also has the volume that is comparable to the common lighters, thereby being portable, and practical.
3. Safe. Safety hazard does not exist in the process of production and transportation; the discharging flam is a micro current high frequent high voltage, and does not bring about any danger or threats to human life.
4. Environmentally friendly. Ozone and negative ions produced from the discharging flame has a positive function in reducing the damage of the ozone layer, improving the atmospheric environment, and human health.
5. Energy saving. The invention is able to save the fuel oil and fuel gas of nonrenewable resource.

### BRIEF DESCRIPTION OF THE DRAWINGS

FIG. 1 is a structure diagram of a lighter in accordance with one embodiment of the invention; and

FIG. 2 is a structure diagram of a lighter after opening a rear part of a casing in accordance with one embodiment of the invention; and

FIG. 3 is a circuit diagram of a lighter in accordance with one embodiment of the invention.

### DETAILED DESCRIPTION OF THE EMBODIMENTS

For further illustrating the invention, experiments detailing a lighter are described below. It should be noted that the following examples are intended to describe and not to limit the invention.

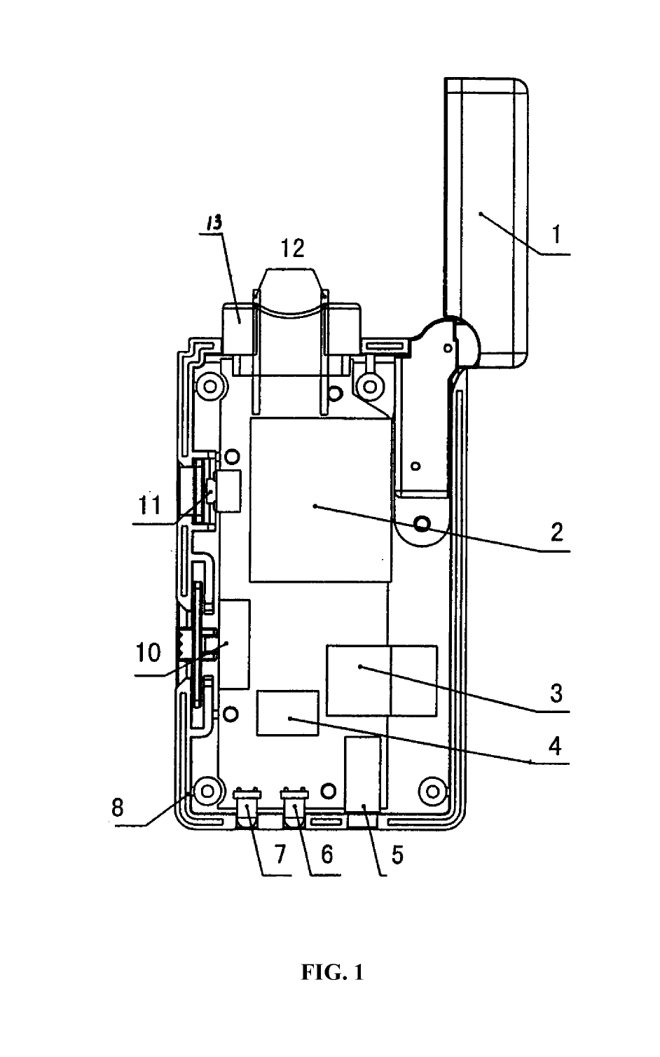

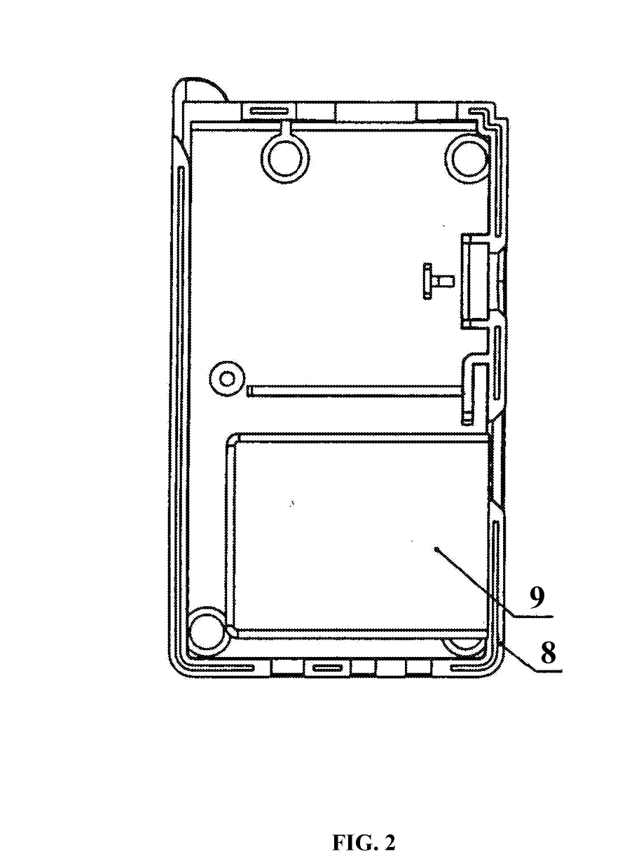

As shown in FIGS. 1-2, a lighter comprises a casing 8. An ignition switch 11 is disposed on an upper side of the casing 8. A toggle switch 10 is disposed on a lower part of the casing 8. The toggle switch 10 is a two-pole three-throw switch. An ignition chamber 2 is disposed inside an upper part of the casing, and a top of the lighter is provided with a pair of high voltage discharging needles 12 connected to the ignition chamber. Circuits are disposed inside the casing 8 on a lower part of the circuit board, and the circuits comprise an oscillating circuit 3, a DC/DC boost converter circuit 4, a lighting circuit 7, and a counterfeit money detector circuit 6. A bottom of the casing 8 is provided with an LED white lamp D₃ for lightening, an LED purple lamp D₄ for money detection, and a power socket 5. A DC power supply 9 is disposed in a lower part inside an opposite of the casing 8. The casing 8 is provided with a turnable cap 1 for protecting the pair of high voltage discharging needles 12 connected to the top of the casing inside the ignition chamber 2 from being polluted and damaged. The pair of high voltage discharging needles 12 is disposed on a high temperature and high voltage-resistant electronic ceramic bracket 13.

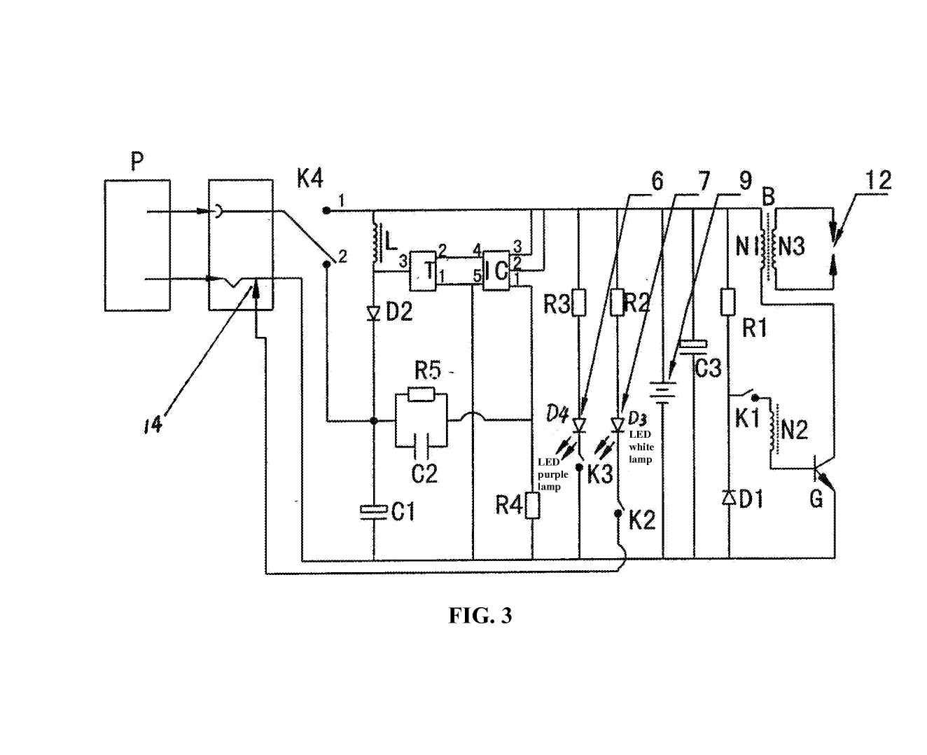

As shown in FIG. 3, the oscillating circuit 3 is a non-sinusoidal self-excited intermittent oscillator formed by connecting a NPN type crystal triode G, a crystal diode D₁, a first resistor R₁, a third electrolytic capacitor C₃, an anion transformer B, a first switch K₁. A collector of the crystal triode G is connected to one end of a primary coil N₁ of the transformer B; and the other end of the primary coil N₁ is connected to one end of the first resistor R₁, a positive electrode of the direct power supply 9, a positive terminal of the third electrolytic capacitor C₃, one end of the second resistor R₂, one end of the third resistor R₃, a second pin IC_{—2} and a third pin IC_{—3} of a integrated circuit IC, one end of a storage inductor L, and a first contact point K₄₋₁ of a fourth switch K₄. One end of a secondary coil N₂ of the transformer B is connected to a base electrode of the crystal triode G; and the other end of the secondary coil N₂ is connected to a series connection point between the first resistor R₁ and the crystal diode D₁ via the first switch K₁. The other end of the crystal diode D₁ is connected to an emitter of the crystal triode G, a negative terminal of the third electrolytic capacitor C₃, a negative electrode of the direct power supply 9, a third switch K₃, one end of the fourth resistor R₄, a first pint T₋₁ of a switching tube T, a fifth pin IC₋₅ of the integrated circuit IC, a negative terminal of a first electrolytic capacitor C₁, a negative terminal of the power socket, and a normally closed contact 14 of the negative terminal of the power socket, and is grounded. The normally closed contact 14 of the negative terminal of the power socket 5 is connected to the second switch K₂. The third resistor R₃ is in series connection with the LED purple lamp for money detection, and the third switch K₃, and is then connected to the negative electrode of the DC current. The other end of the fourth resistor R₄ is connected to the first pin IC₋₁ of the integrated circuit, one end of the fifth resistor R₅, and one end of the second capacitor C₂. The other end of the fifth resistor R₅ is connected to the other end of the second capacitor C₂, the positive terminal of the first electrolytic capacitor C₁, one end of the crystal diode D₂, a second contact point K₄₋₂ of the fourth switch K₄. The other end of the crystal diode D₂ is connected to the other end of the storage inductor L, a third pin T₋₃ of the switching tube T. A second pin T₋₂ of the switching tube T is connected to a fourth pin IC₋₄ of the integrated circuit IC.

When using the lighter of the invention, turn up the turnable cap 1 arranged on the upper part of the casing, so that the first switch K₁ is connected, the oscillator works, and a high frequency oscillation having a frequency of 50 kHz is produced. Coupled by the anion transformer B, two ends of the tertiary coil N₃ produce a high frequent high voltage which is then arc discharged by the pair of high voltage discharging needles inside the ignition chamber. Flame produced from the discharge is used to ignite combustible materials. When the toggle switch 10 is turned upward, the second switch K₂ and the first contact point K₄₋₁ of the fourth switch K₄ are connected, thus, the lighting circuit is connected; and LED white light is lightened and functions as a lighting source. When the DC power supply of the invention has a low energy and requires to be charged, a plug of the external DC power charger, a solar power charger, or a computer USB interface is inserted into the power socket 5 through a conversion line; thus, the normally closed contact of the negative terminal of the power socket 5 is disconnected, the lighting circuit 7 is disconnected during the power charging, while the negative terminal of the power socket 5 is connected, so that the DC power supply 9 is connected in the charging circuit for obtaining power from an external power charger.

When the toggle switch is turned downward, the third switch K₃ is closed, the counterfeit money detector circuit is connected, and the LED purple light for money detection is lightened. When the toggle switch is turned at the middle position, the second contact point K₄₋₂ of the fourth switch K₄ is connected and the DC/DC boost converter circuit works. The DC/DC boost converter circuit is formed by connecting the integrated circuit IC, the switching tube T, the fourth resistor R₄, the fifth resistor R₅, the first capacitor C₁, the second capacitor C₂, the crystal diode D₂, and the storage inductor L. The DC voltage of the DC power supply 9 passes through the integrated circuit IC, and outputs a control signal from the fourth pin of the integrated circuit IC.

When the control signal is a high level, the input of the second pin T₋₂ of the switching tube T is a high level. The switching tube T is conducted, and the energy enters through the DC power supply 9, and is stored in the inductor L. Because when the switching tube conducted, the saturated voltage drop is very small, the second diode D₂ is reverse-biased and cut off, and the energy stored in the first filter capacitor C₁ is discharged to the load. When the control signal is a low level, the input of the second pin T₋₂ of the switching tube T is a low level, the switching tube is cut off. As the current break does not exist in the inductor L, the induced voltage prevents the current from decreasing, the polarity of the induced voltage is negative on the upper and positive on the lower, the second diode D₂ is conducted. The energy stored in the inductor L passes through the second diode D₂ for charging the first filter capacitor C₁ while supplying the load. When the switch frequency and the duty ratio of the switching tube are properly adjusted, a DC voltage output that is stable and higher than the voltage of the DC power supply 9 is produced between the ground and the second contact point K₄₋₂ of the output end of the fourth switch K₄. Thus, the lighter of the invention is capable of charging cell phones or other digital products suitable for cell phone batteries through the power socket 5 and conversion lines. The DC/DC boost converter circuit works, the DC voltage after voltage boosting is used to charge the cell phone or other digital products that are applicable to battery of cell phone by the second contact point K₄₋₂ of the fourth switch. In the open air, the DC power supply of the lighter of the invention can be charged by using the power socket 5 and the solar energy power charger.

In the specifications, if no special instructions, data ranges disclosed herein include the initial and terminal of the dada rather than exclude them.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A lighter, comprising:
a) a casing (8);
b) a turnable cap (1);
c) a circuit board;
d) a transformer (B);
e) a power supply (9);
f) switches, the switches comprising an ignition switch (11), a toggle switch (10), a first switch (K₁), a second switch (K₂), a third switch (K₃), and a fourth switch (K₄);
g) circuits, the circuits comprising an oscillating circuit (3), a DC boost converter circuit (4), a lighting circuit (7), and a counterfeit money detector circuit (6);
h) a power socket (5);
i) an ignition chamber (2); and
j) a pair of discharging needles (12);
wherein
the circuits are disposed on the circuit board;
the circuit board is arranged inside the casing, and the discharging needles are disposed on a top of the ignition chamber;
the ignition switch (11) and the toggle switch (10) are disposed on one side of the casing (8); a bottom of the casing is provided with a lighting lamp and a counterfeit money detector lamp;
the oscillating circuit (3) comprises a crystal triode (G), a first crystal diode (D₁), a first resistor (R₁), a third capacitor (C₃), a primary coil (N₁) and a secondary coil (N₂) of the transformer (B); a series connection of the first resistor (R₁) and the first crystal diode (D₁) is connected to the power supply in parallel to the third capacitor (C₃); a base electrode of the crystal triode (G) is connected to a series connection point between the first resistor (R₁) and the first crystal diode (D₁) via the secondary coil (N₂) and the first switch (K₁); a collector of the crystal triode (G) is connected to an positive electrode of the power supply, and an emitter of the crystal triode (G) is connected to a negative electrode of the power supply;
the DC boost converter circuit (4) comprises an integrated circuit (IC), a switching tube (T), a second diode (D₂), a fourth resistor (R₄), a fifth resistor (R₅), a first capacitor (C₁), a second capacitor (C₂), and an inductor (L); a first pin (IC₋₁) of the integrated circuit is connected to a series connection point between the fourth resistor (R₄) and the fifth resistor (R₅); and the other end of the fourth resistor (R₄) is connected to the negative electrode of the power supply; the second capacitor (C₂) is in parallel connection with the fifth resistor (R₅); the other end of the fifth resistor (R₅) is connected to the second diode (D₂), the first capacitor (C₁), a second contact point (K₄₋₂) of the fourth switch (K₄); the other end of the second diode (D₂) is connected to a third pin (T₋₃) of the switching tube (T), and one end of the inductor (L); the other end of the inductor (L) is connected to a positive electrode of the power supply; the other end of the first capacitor (C₁) is connected to the negative electrode of the power supply; a second pin (T₋₂) of the switching tube (T) is connected to a fourth pin (IC₋₄) of the integrated circuit; and a first pin (T₋₁) of the switching tube (T) is connected to a fifth pin (IC₋₅) of the integrated circuit, and then is connected to the negative electrode of the power supply;
the lighting circuit (7) comprises a third diode (D₃), a second resistor (R₂), the second switch (K₂), and a normally closed contact of a negative terminal of the power socket; a series connection of the third diode (D₃) and the second resistor (R₂) is connected to the power supply via the second switch (K₂) and the normally closed contact of the negative terminal of the power socket; and
the counterfeit money detector circuit (6) comprises a fourth diode (D₄), a third resistor (R₃), and the third switch (K₃); the fourth diode (D₄), the third resistor (R₃), and the third switch (K₃) are in series connection to the power supply.

2. The lighter of claim 1, wherein
the transformer (B) comprises the primary coil (N₁), the secondary coil (N₂), and a tertiary coil (N₃), a ratio of coil turn thereof is N₁:N₂:N₃=1:0.5-0.9:50-70; and
two ends of the tertiary coil (N₃) are connected to the pair of discharging needles in the ignition chamber, respectively.

3. The lighter of claim 1, wherein the power supply (9) is a rechargeable battery.

4. The lighter of claim 1, wherein the ignition switch (11) is a toggle switch or a touching switch.

5. The lighter of claim 1, wherein
the toggle switch (10) is a two-pole three-throw switch;
the second switch (K₂) and a first contact point (K₄₋₁) of the fourth switch (K₄) are connected if the toggle switch (10) is turned upward;
the third switch (K₃) is connected if the toggle switch (10) is turned downward; and
the second contact point (K₄₋₂) of the fourth switch (K₄) is connected if the toggle switch (10) is turned at a middle position.

6. The lighter of claim 1, wherein the power socket (5) cooperates with a power charger or a computer USB interface for charging the power supply (9) via a conversion line.

7. The lighter of claim 1, wherein the power supply is connected to the DC boost converter circuit (4) for charging a cell phone or other digital products applicable to a battery of the cell phone via the power socket (5).

8. The lighter of claim 1, wherein the discharging needles are mounted on an electronic ceramic bracket (13).

9. The lighter of claim 1, wherein the third diode (D₃) is an LED white tube, and the fourth diode (D₄) is an LED purple tube.
